(19) United States
(12) Patent Application Publication
(10) Pub. No.: US 2018/0124664 A1
(43) Pub. Date: May 3, 2018

(54) METHOD AND APPARATUS FOR TRIGGERED TELEMATICS CARRIER SWAP

(71) Applicant: FORD GLOBAL TECHNOLOGIES, LLC, Dearborn, MI (US)

(72) Inventors: Oliver LEI, Windsor (CA); Allen R. MURRAY, Lake Orion, MI (US)

(21) Appl. No.: 15/335,888

(22) Filed: Oct. 27, 2016

(51) Int. Cl. H04W 36/14; H04W 4/00

(52) U.S. Cl. CPC H04W 36/14; H04B 17/318; H04W 4/001

(57) ABSTRACT

A system includes a processor configured to determine that a cellular signal strength has dropped below a predefined threshold strength. The processor is also configured to request a new cellular carrier from a remote network, responsive to the determination that the signal strength has dropped below the threshold. Also, the processor is configured to receive carrier reprogramming instructions from the remote network, including a new cellular carrier subscription profile and swap a current subscription profile with the new cellular carrier subscription profile.

### TECHNICAL FIELD

The illustrative embodiments generally relate to a method and apparatus for triggered telematics carrier swap.

### BACKGROUND

Onboard remote network access has become so prevalent that vehicle owners are coming to expect some level of connectivity when purchasing a vehicle of a certain class or above. Many original equipment manufacturers (OEMs) provide vehicles with onboard modems to facilitate telecommunication and telematics transfers, allowing the vehicle to leverage an external connection using only onboard components.

Just like cellular phones, however, these onboard modems may suffer from network issues in areas of low or no coverage. Typically, the vehicle OEM will designate the cellular carrier for the vehicle modem, and a given OEM may have an exclusive contract with a particular carrier, or may use multiple carriers across vehicle lines and national locations.

For example, if an OEM selected AT&T for one location based on network coverage and provided every vehicle sold in that location with a modem supported by AT&T, the same OEM might have selected VERIZON or SPRINT for another area, and provided vehicles in that area with modems supported by the selected carrier. This could be because a particular area has the best coverage under a particular provider. The potential problem with this model, however, is that if a vehicle owner travels to an area of low coverage for the provider assigned to that vehicle, the owner may experience connectivity issues.

### SUMMARY

In a first illustrative embodiment, a system includes a processor configured to determine that a cellular signal strength has dropped below a predefined threshold strength. The processor is also configured to request a new cellular carrier from a remote network, responsive to the determination that the signal strength has dropped below the threshold. Also, the processor is configured to receive carrier reprogramming instructions from the remote network, including a new cellular carrier subscription profile and swap a current subscription profile with the new cellular carrier subscription profile.

In a second illustrative embodiment, a computer-implemented method includes identifying an alternative cellular network having a signal strength above the threshold, responsive to a detected signal strength for a current cellular network falling below a predetermined threshold. The method also includes requesting a cellular subscription profile from a remote network, enabling use of the identified alternative cellular network. Additionally, the method includes swapping an onboard cellular subscription profile of a vehicle modem to a new cellular subscription profile received responsive to the request.

In a third illustrative embodiment, a system includes a processor configured to receive a request for a new cellular carrier subscription profile from a vehicle, the request including vehicle location information. The processor is also configured to determine a cellular carrier, based on the location information, having a usable cellular network and send a reconfiguration response, including a subscription profile for the determined cellular carrier.

### BRIEF DESCRIPTION OF THE DRAWINGS

FIG. 1 shows an illustrative vehicle computing system;

FIG. 2 shows an illustrative process for cellular carrier swap;

FIG. 3 shows an illustrative process for predictive carrier swap; and

FIG. 4 shows an illustrative process for carrier selection.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

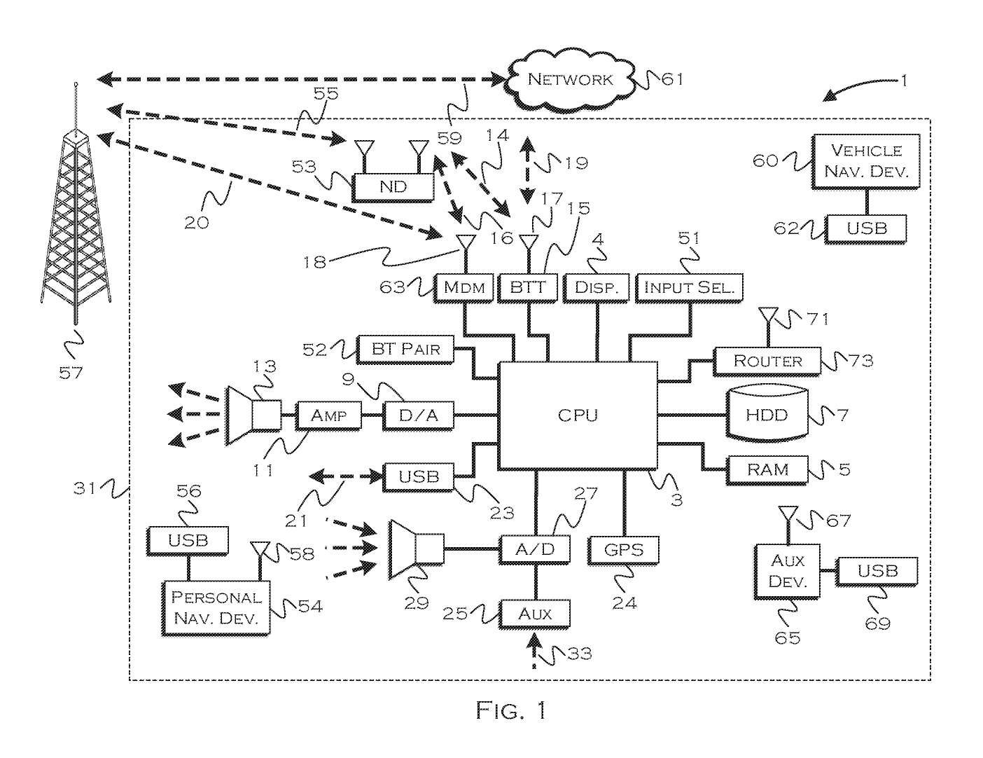

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a Wi-Fi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include Wi-Fi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., Wi-Fi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a Wi-Fi (IEEE 802.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing that portion of the process, since the wireless device would not “send and receive” information with itself. One of ordinary skill in the art will understand when it is inappropriate to apply a particular computing system to a given solution.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

With respect to the illustrative embodiments described in the figures, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

The illustrative embodiments provide solutions that allow an OEM to dynamically swap vehicle modem carriers as a vehicle experiences low or lost service. A remote server is capable of sending new carrier information to a vehicle, which can then be used by a vehicle telematics service to swap to a new carrier for use by a vehicle modem.

Since it is difficult for a remote network to decide when to swap a carrier, because by the time the remote network determines that a vehicle is experiencing a low signal, the signal may be lost and the swap may not be able to occur, in one example the telematics control unit (TCU) monitors the signal strength for determining when a swap can occur.

That said, it is also possible to report signal strength to a remote network, or report vehicle location so a remote network can determine when an upcoming signal loss (based on known coverage areas) might occur, if the network-as-monitor model is desired. In the illustrative examples, the TCU will perform the monitoring and reporting of upcoming or occurring signal loss.

Because a complete loss of signal may make the transfer of carriers impossible (since the TCU may not have access to a new carrier profile), the TCU will typically inform the remote network of the impending potential signal loss by sending a request for a new carrier when a signal drops below a predefined reasonable threshold. This is designed to provide ample time for obtaining new carrier details while a usable signal under the old carrier still exists.

In other examples, a backup profile may be stored on a vehicle, which can be used if the primary carrier is lost entirely before a swap can occur. Or, in another example, a secondary connection source (cellular phone, Wi-Fi network, etc) can be used to send the request for carrier swap, if the present carrier signal provided to the TCU modem is insufficiently strong to complete the swap transfer. In some current paradigms, the over the air subscription reprogramming needs to be done remotely, which is why allowing the TCU to request the swap before the signal degrades entirely may be a useful solution if such a remote reprogramming constraint exists. Such a process for carrier swap may be useful in both manually driven and autonomous vehicles.

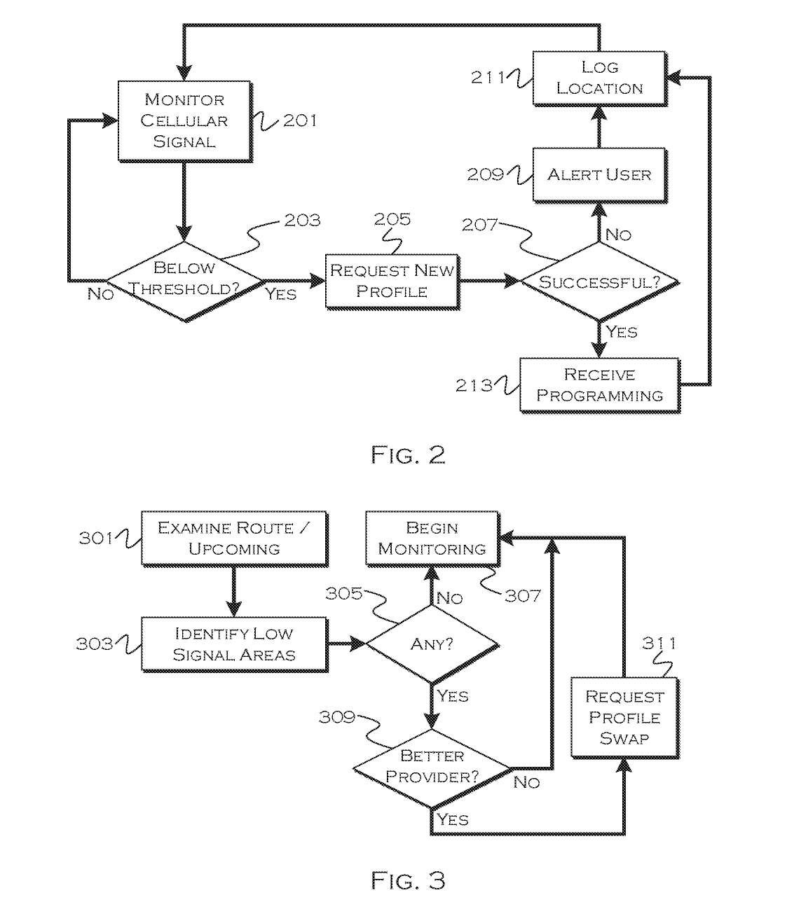

FIG. 2 shows an illustrative process for cellular carrier swap. In this illustrative example, the TCU or a vehicle application monitors a current cellular signal 201. This can involve, for example, monitoring the received signal for a signal drop below a certain predefined threshold, or, for example, examining a signal map for upcoming locations along a route to determine if there are any areas of total signal loss upcoming. The latter solution may be useful when the signal goes from strong to 0, without a slow degradation.

If the monitored signal drops below a predefined threshold 203, the process (the TCU, in this example) requests a new cellular profile for use by the TCU modem 205. This request is sent to the backend remote server, which selects a best or preferred new carrier and programs the selected profile to the TCU.

In one model, the TCU may observe the available signal strengths of other in-area cellular networks, and designate a particular new network for utilization based on observed signal strengths. The TCU may observe all available networks, or a subset of networks based on those which are known to be available for swap by the remote server. In another model, the backend server will designate a new network based on a vehicle location and known network coverage. In the former case, the TCU can send a request without any vehicle location information, while in the latter model it is likely that some form of vehicle location information may need to be sent.

On the other hand, while the TCU may be able to identify a current “best” cellular carrier, the backend network may have more extensive information about the known range and signal quality of a variety of carriers. That is, the current “best” carrier may only be the best carrier for a limited distance, whereas a different carrier may provide better and more consistent coverage over a route.

If the backend server is able to identify a useable new carrier 207, the process receives reprogramming from the remote server 213. This will swap the usable cellular carrier to the new carrier. Reversion to the old carrier can occur when the vehicle restarts, or after the vehicle travels outside a known area of low coverage. In one example, the vehicle maintains usage of the new carrier until reaching an area of known coverage for the original carrier, so that the vehicle does not reset carriers upon restart, only to have no available signal for reprogramming request.

Also, an OEM may not care which vehicle is using which particular carrier, in which case the new carrier may simply persist until the vehicle encounters an area of low coverage for that particular carrier.

If the remote server cannot identify a usable new carrier 207, the process may inform the user 209 that connectivity may be lost for some period of time. The process then logs the area of travel where there is no signal available on any known or usable network 211. This log can be used in route planning, and can be reported to the OEM so that the OEM can decide if another carrier is needed to accommodate a high volume of users reporting loss in a particular area.

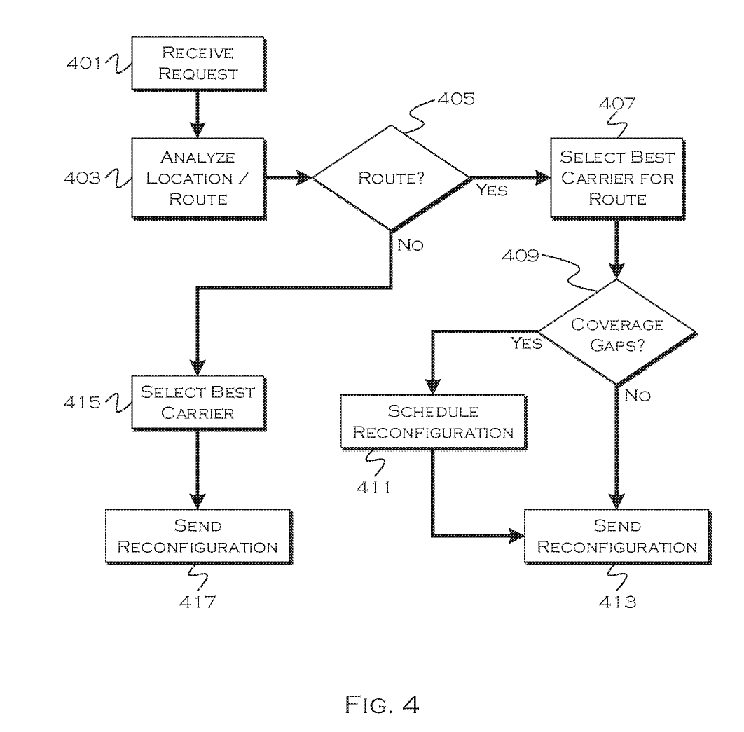

FIG. 3 shows an illustrative process for predictive carrier swap. In this illustrative example, the process will predictively plan for areas of predicted carrier loss, over a known route. Once a route has been determined (predicted or input), the process examines the route and/or upcoming areas along a route already in progress 301. The process may then identify (by correlation to known data, for example) any known areas of upcoming signal loss 303. In a crowd-sourced model, vehicles currently on the road could be reporting connectivity data to a central location, so if this process ran on a server, for example, the server could update the connectivity loss data with current data, in case weather or excessive usage (e.g., a sporting event) was causing short term connectivity issues in a particular area.

If there are no areas of known connectivity loss or degradation below an acceptable level expected 305, the process may engage a monitoring function 307 to track the signal over the course of travel.

If there are one or more areas of known connectivity loss, over the course of the route (or over an upcoming area, based on speed and heading, for example, if this process is used for spot prediction) the process determines if a better provider is available 309. If there is no better provider available, the process maintains current provider usage and engages monitoring 307. If a better provider exists, the process may request a profile swap 311. If a predictive profile swap is requested, the process may request reversion to the old profile, or reversion may be automatic, once the vehicle leaves the area of low or no coverage. In other examples, the vehicle will simply use the new provider until coverage quality dictates another swap.

FIG. 4 shows an illustrative process for carrier selection. In this illustrative example, the process receives a request to provide an alternative telematics carrier 401. In some examples, the process may also simply receive a current location and/or speed and heading and be asked to determine if a telematics swap is needed. In this example, however, the vehicle TCU or other module has determined that a new telematics carrier may be needed, and sends the request for a new carrier to the process.

Once the process has received some vehicle location data, be it a current location, route, speed and heading or other appropriate data, the process analyzes the data against known cellular carrier coverage maps or other similar data, to determine an appropriate carrier 403.

If the process did not receive a vehicle route, but merely received either location data and/or speed and heading data the process selects the best carrier for the current location 415. If the process received speed and heading data, the process may also ensure the selected carrier likely has coverage in the direction in which the vehicle appears to be heading, at least for the short term. The process then sends reconfiguration instructions instructing telematics carrier reconfiguration to the selected best carrier.

If a route was received, the process can select a best carrier for the route 407. That is, even if a “best” carrier exists for a current location (best being strongest signal in this example), that carrier may not be the best carrier for the entire route, as the vehicle route may carry the vehicle out of an area of coverage for that carrier.

The process selects the best present carrier based on current vehicle location and/or some portion of the upcoming route. This can involve choosing between several carriers that may have varied present coverage, to provide, for example, the best average signal strength that also remains above a certain threshold.

The process then determines if there are any coverage gaps for the selected carrier along the route. In this example, if the selected current “best” carrier has known coverage gaps along a route, the process also schedules reconfiguration to a new “best” carrier at those locations 411. In another example, the process may forego selection of the present “best” carrier, in the interest of selecting a carrier that may not presently be as good as the best carrier, but that provides coverage over the entire route at an acceptable level. The choice of models can depend on, for example, how frequently a carrier swap is desired and/or how efficient and cost-effective a carrier swap is.

Once the particular new carrier has been selected, under the model chosen for selecting a new carrier, the process sends a reconfiguration instruction 413. If the process has also scheduled other reconfigurations, the process may send this data to the vehicle as well, in order to alert the TCU or other module to a location where a new carrier should be requested or is likely to be needed. The TCU receives the reconfiguration instruction, along with a new cellular carrier subscription profile and then swaps subscription profiles between a new subscription and the old, present subscription.

By using the ability of an OEM to dynamically reassign cellular carriers, the illustrative embodiments provide a solution that allows for a vehicle to maintain consistent and persistent cellular connectivity over a variety of network coverage areas, and helps ensure that no vehicle travels without connectivity unless in an area where simply no cellular coverage is available.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a processor configured to:
determine that a cellular signal strength has dropped below a predefined threshold strength;
responsive to the determination that the signal strength has dropped below the threshold, request a new cellular carrier from a remote network;
receive carrier reprogramming instructions from the remote network, including a new cellular carrier subscription profile; and
swap a current subscription profile with the new cellular carrier subscription profile.

2. The system of claim 1, wherein the processor is further configured to:
identify a cellular carrier having a current signal strength above the predefined threshold; and
send the identified cellular carrier in the request as the new cellular carrier.

3. The system of claim 2, wherein the processor is further configured to identify a cellular carrier having a highest current signal strength from a plurality of available cellular carriers; and
send the identified cellular carrier in the request as the new cellular carrier.

4. The system of claim 1, wherein the processor is configured to send vehicle location information as part of the request.

5. The system of claim 4, wherein the location information includes vehicle location coordinates.

6. The system of claim 4, wherein the location information includes vehicle route details.

7. The system of claim 4, wherein the location information includes vehicle heading and speed information.

8. The system of claim 1, wherein the processor is configured to determine signal strengths for a plurality of alternative cellular carriers; and
send the determined signal strengths as part of the request.

9. A computer-implemented method comprising:
responsive to a detected signal strength for a current cellular network falling below a predetermined threshold, identifying an alternative cellular network having a signal strength above the threshold;
requesting a cellular subscription profile from a remote network, enabling use of the identified alternative cellular network; and
swapping an onboard cellular subscription profile of a vehicle modem to a new cellular subscription profile received responsive to the request.

10. The method of claim 9, further comprising identifying a plurality of alternative cellular networks having signal strengths above the threshold and including the plurality of alternative cellular networks in the request.

11. The method of claim 10, further comprising identifying a preferred one of the plurality of alternative cellular networks in the request.

12. The method of claim 9, further comprising including vehicle location information in the request.

13. A system comprising:
a processor configured to:
receive a request for a new cellular carrier subscription profile from a vehicle, the request including vehicle location information;
determine a cellular carrier, based on the location information, having a usable cellular network; and
sending a reconfiguration response, including a subscription profile for the determined cellular carrier.

14. The system of claim 13, wherein the processor is configured to determine the new cellular carrier based on a cellular carrier network having a known strength above a threshold over at least a predetermined upcoming distance along a route, received as part of the vehicle location information.

15. The system of claim 14, wherein the processor is configured to determine the new cellular carrier based on the cellular carrier network having the highest signal strength over the predetermined upcoming distance, from a plurality of alternative cellular carrier networks.

16. The system of claim 15, wherein the processor is configured to determine if the new cellular carrier network includes any areas of signal strength below the threshold along the route.

17. The system of claim 16, wherein the processor is configured to:
determine an alternative cellular carrier for the new cellular carrier having a signal strength above the threshold over any areas of new cellular carrier network signal strength below the threshold along the route; and
include in the reconfiguration response a cellular subscription profile for the alternative cellular carrier and instructions to use the cellular subscription profile for the alternative cellular carrier when the vehicle reaches the areas of new cellular carrier network signal strength below the threshold.

18. The system of claim 13, wherein determining the usability of the cellular network includes at least determining that a current signal strength is above a predetermined threshold.

19. The system of claim 13, wherein the processor is configured to determine the new cellular carrier based on a cellular carrier network having a known strength above a threshold over at least a predetermined upcoming distance, the distance determined based on vehicle speed and heading received as part of the vehicle location information.

20. The system of claim 13, wherein the processor is configured to determine the new cellular carrier based on a cellular carrier network having a known strength above a threshold over an entire route, received as part of the vehicle location information.
